(19) United States
(12) Patent Application Publication
(10) Pub. No.: US 2013/0169488 A1
(43) Pub. Date: Jul. 4, 2013

(54) MAGNETIC SUBSTANCE AND COMPOSITE MATERIAL FOR ANTENNAS EMPLOYING THE SAME

(71) Applicants: Jun-sig KUM, Asan-si (KR); Nak-hyun KIM, Suwon-si (KR); Hyun-jin KIM, Seoul (KR); Seung-kee YANG, Suwon-si (KR); Joong-hee LEE, Seongnam-si (KR)

(72) Inventors: Jun-sig KUM, Asan-si (KR); Nak-hyun KIM, Suwon-si (KR); Hyun-jin KIM, Seoul (KR); Seung-kee YANG, Suwon-si (KR); Joong-hee LEE, Seongnam-si (KR)

(73) Assignee: SAMSUNG ELECTRONICS CO., LTD., Suwon-si (KR)

(21) Appl. No.: 13/604,685

(22) Filed: Sep. 6, 2012

(30) Foreign Application Priority Data
Dec. 28, 2011 (KR) 10-2011-0145013

(51) Int. Cl. H01F 1/01; C04B 35/64; H01Q 1/38; B32B 5/16

(52) U.S. Cl. 343/700 MS; 252/62.57; 252/62.6; 252/62.63; 252/62.59; 252/62.54; 428/402; 264/611

(57) ABSTRACT

A new magnetic substance having a high magnetic permeability and a low magnetic permeability loss over a wide frequency bandwidth, a composite material for antennas using the new magnetic substance and a polymer, and an antenna using the composite material for antennas.

### CROSS-REFERENCE TO RELATED PATENT APPLICATION

This application claims priority from Korean Patent Application No. 10-2011-0145013, filed Dec. 28, 2011 in the Korean Intellectual Property Office, the disclosure of which is incorporated by reference herein in its entirety.

### BACKGROUND OF THE INVENTION

1. Field of the Invention

The present invention relates to a magnetic substance and a composite material for antennas employing the same.

2. Description of the Related Art

In wireless communication systems such as mobile phones, wireless LANs, or the like, demand for higher data transfer rates has been greater than ever before. One critical element necessary for implementing a reliable high-speed data transfer rate is antennas. Antennas, for example, collect or release radio waves such as carrier waves in which signals are included.

Portable wireless communication systems require antennas that are small in size and efficient. Moreover, a tendency of portable wireless communication systems to use internal antennas to implement multi-functionality and improve portability has been stronger than ever before.

A compact internal antenna may be manufactured by forming a pattern of circuit features on a dielectric carrier formed from a high-k dielectric. Alternatively, a ferrite having a high magnetic permeability, instead of a high-k dielectric, may be used.

In an antenna using a dielectric, a resonant frequency bandwidth is narrow. To expand the bandwidth, a larger size is necessary. As a result, a dielectric antenna is unsuitable for use as a compact internal antenna.

To solve such a problem, it has been suggested to use an antenna comprising a magnetic substance having a magnetic permeability. However, a magnetic substance antenna has been known to have both a high magnetic permeability and a high magnetic permeability loss at high frequency. Accordingly, it is known that a magnetic substance antenna has a low efficiency at high frequency.

Also, dielectrics and magnetic substances are molded via a sintering process. Due to the limitations in such a molding method, it is difficult to easily install a dielectric antenna or a magnetic substance antenna in a portable wireless communication system, and such antennas have low reliability.

### SUMMARY OF THE INVENTION

One or more exemplary embodiments provide a new magnetic substance having a high magnetic permeability and a low magnetic permeability loss over a wide frequency bandwidth.

One or more embodiments also provide a composite material for antennas employing the new magnetic substance and a polymer.

One or more exemplary embodiments also provide an antenna employing the composite material for antennas.

According to an aspect of an exemplary embodiment, there is provided a magnetic substance including a compound represented by Formula 1 below:

Ba₂₋ₚSrₚCo_{2-y-z}Zn_{y}M¹_{z}Fe_{12-q}M²_{q}O₂₂, <Formula 1>

wherein M¹ is at least one element selected from the group consisting of Mn, Cu, Ni, and Mg, M² is at least one element selected from the group consisting of La and Y, p is about 0 to about 1, y is about 0.1 to about 0.9, z is about 0 to about 0.8, and q is about 0 to about 1.

According to an aspect of another exemplary embodiment, there is provided a method of manufacturing a magnetic substance including: forming a slurry mixture by mixing a Ba-precursor in an amount of 2-p parts by mole based on the Ba element, a Sr-precursor in an amount of about p parts by mole based on the Sr element, a Co-precursor in an amount of about 2-y-z parts by mole based on the Co element, a Zn-precursor in an amount of about y parts by mole based on the Zn element, an M¹-precursor in an amount of about z parts by mole based on the M¹ element, an Fe-precursor in an amount of about 12-q parts by mole based on the Fe element, and an M²-precursor in an amount of about q parts by mole based on the M² element, in the presence of a dispersion medium, wherein M¹ is at least one element selected from the group consisting of Mn, Cu, Ni, and Mg, the M¹-precursor is at least one compound selected from the group consisting of an Mn-precursor, a Cu-precursor, an Ni-precursor, and an Mg-precursor, M² is at least one element selected from the group consisting of La and Y, the M²-precursor is at least one compound selected from the group consisting of an La-precursor and a Y-precursor, p is about 0 to about 1, y is about 0.1 to about 0.9, z is about 0 to about 0.8, and q is about 0 to about 1; forming a dry mixture by drying the slurry mixture; and forming a magnetic substance by calcining the dry mixture.

The method may further include: forming a second slurry mixture by mixing the calcined magnetic substance and silicate glass in the presence of a second dispersion medium; forming a second dry mixture by drying the second slurry mixture; forming a compressed mixture by compressing the second dry mixture; and sintering the compressed mixture.

According to an aspect of another exemplary embodiment, there is provided a composite material for antennas including: a thermoplastic polymer resin matrix; and a magnetic substance powder which is dispersed in the matrix, the powder including a compound represented by Formula 1 below:

Ba₂₋ₚSrₚCo_{2-y-z}Zn_{y}M¹_{z}Fe_{12-q}M²_{q}O₂₂, <Formula 1>

wherein M¹ is at least one element selected from the group consisting of Mn, Cu, Ni, and Mg, M² is at least one element selected from the group consisting of La and Y, p is about 0 to about 1, y is about 0.1 to about 0.9, z is about 0 to about 0.8, and q is about 0 to about 1.

According to an aspect of another exemplary embodiment, there is provided an antenna including: the antenna carrier formed of the composite material for antennas; and a resonance circuit pattern formed on a surface of the antenna carrier.

### BRIEF DESCRIPTION OF THE DRAWINGS

The above and other aspects will become more apparent by describing in detail exemplary embodiments with reference to the attached drawings in which:

FIG. 1 is a graph showing a change in a relative magnetic permeability of magnetic substance powders of Examples 1 through 4 according to frequency;

FIG. 2 is a graph showing a change in a magnetic permeability loss of the magnetic substance powders of Examples 1 through 4 according to frequency;

FIG. 3 is a graph showing a change in a relative magnetic permeability of composite materials for antennas of Examples 9 through 12 according to frequency;

FIG. 4 is a graph showing a change in a magnetic permeability loss of the composite materials for antennas of Examples 9 through 12 according to frequency;

FIG. 5 is a graph showing a change in a relative dielectric permittivity of the composite materials for antennas of Examples 9 through 12 according to frequency;

FIG. 6 is a graph showing a change in a dielectric loss of the composite materials for antennas of Examples 9 through 12 according to frequency;

FIG. 7 is a graph showing a change in a relative magnetic permeability of composite materials for antennas of Examples 15 through 20 according to frequency;

FIG. 8 is a graph showing a change in a magnetic permeability loss of the composite materials for antennas of Examples 15 through 20 according to frequency;

FIG. 9 is a graph showing a change in a relative dielectric permittivity of the composite materials for antennas of Examples 15 through 20 according to frequency;

FIG. 10 is a graph showing a change in a dielectric loss of the composite materials for antennas of Examples 15 through 20 according to frequency;

FIG. 11 is a scanning electron microscope (SEM) image (×1,000) of the composite material for antennas (PC-ABS, magnetic substance 50 wt %) of Example 19;

FIG. 12 is an SEM image (×5,000) of the composite material for antennas (PC-ABS, magnetic substance 50 wt %) of Example 19;

FIG. 13 is a SEM image (×1,000) of the composite material for antennas (PC-ABS, magnetic substance 68 wt %) of Example 20;

FIG. 14 is a SEM image (×5,000) of the composite material for antennas (PC-ABS, magnetic substance 68 wt %) of Example 20;

FIG. 15 is an image of an antenna carrier of Example 21; and

FIG. 16 is an image of an antenna of Example 22.

### DETAILED DESCRIPTION OF EXEMPLARY EMBODIMENTS

A magnetic substance according to an exemplary embodiment includes a compound represented by Formula 1 below:

Ba₂₋ₚSrₚCO_{2-y-z}Zn_{y}M¹_{z}Fe_{12-q}M²_{q}O₂₂, <Formula 1>

Here, M¹ is at least one element selected from the group consisting of Mn, Cu, Ni, and Mg, M² is at least one element selected from the group consisting of La and Y, p is about 0 to about 1, y is about 0.1 to about 0.9, z is about 0 to about 0.8, and q is about 0 to about 1.

Alternatively, in Formula 1, z may be about 0.1 to about 0.4.

The magnetic substance according to Formula 1 has a high magnetic permeability and a low magnetic permeability loss over a wide frequency bandwidth. For example, the magnetic substance according to Formula 1 may have a relative magnetic permeability of about 2 or greater, or a relative magnetic permeability of from about 3 to about 5, over an entire bandwidth of 100 MHz to 3 GHz. Also, the magnetic substance according to Formula 1 may have, for example, a magnetic permeability loss of about 0.9 or lower, or a magnetic permeability loss of about 0.1 to about 0.5, over the entire bandwidth of 100 MHz to 3 GHz.

The magnetic substance of Formula 1 may have, for example, a Y-type hexagonal ferrite structure.

Another exemplary embodiment of a magnetic substance may further include silicate glass.

The silicate glass may be, for example, silica glass, fumed silica glass, borosilicate glass, aluminosilicate glass, lithium silicate glass, potassium silicate glass, sodium silicate glass, barium silicate glass or a mixture thereof.

The content of the silicate glass may be, for example, about 0.5 parts by weight to about 5 parts by weight based on 100 parts by weight of the compound represented by Formula 1.

The magnetic substance according to another exemplary embodiment may be in powder form. In this case, an average particle size of the magnetic substance may be about 0.5 μm to about 5 μm, or about 1 μm to about 3 μm.

A method of manufacturing the magnetic substance according to an exemplary embodiment includes forming a slurry mixture by mixing about 2-p parts by mole of a Ba-precursor based on an amount of Ba, about p parts by mole of a Sr-precursor based on an amount of Sr, about 2-y-z parts by mole of a Co-precursor based on an amount of Co, about y parts by mole of a Zn-precursor based on an amount of Zn, z parts by mole of an M¹-precursor based on an amount of M¹, about 12-q parts by mole of an Fe-precursor based on an amount of Fe, and about q parts by mole of an M²-precursor based on an amount of M² in the presence of a dispersion medium, wherein M¹ is at least one element selected from the group consisting of Mn, Cu, Ni, and Mg, the M¹-precursor is at least one compound selected from the group consisting of an Mn-precursor, a Cu-precursor, an Ni-precursor, and an Mg-precursor, M² is at least one element selected from the group consisting of La and Y, the M²-precursor is at least one compound selected from the group consisting of an La-precursor and a Y-precursor, p is about 0 to about 1, y is about 0.1 to about 0.9, z is about 0 to about 0.8, and q is about 0 to about 1; forming a dry mixture by drying the slurry mixture; and forming a magnetic substance by calcining the dry mixture.

As the dispersion medium, for example, water, an alcohol compound, or a mixture thereof may be used. The water may be, for example, deionized water, distilled water, or a mixture thereof. The alcohol compound may be, for example, ethanol, propanol, butanol, pentanol, or a mixture thereof.

For example, an amount of the dispersion medium used may be within a range from about 40 parts by weight to about 70 parts by weight based on 100 parts by weight of a total weight of the Ba-precursor, the Sr-precursor, the Co-precursor, the Zn-precursor, the M¹-precursor, the Fe-precursor, and the M²-precursor.

The Ba-precursor may be, for example, BaCO₃, BaCl₂, BaF₂, or a mixture thereof. The Sr-precursor may be, for example, SrCO₃, SrCl₂, or a mixture thereof. The Co-precursor may be, for example, Co₃O₄, CoO, CoCl₂, or a mixture thereof. The Zn-precursor may be, for example, ZnO, Zn, ZnCl₂, or a mixture thereof. The Mn-precursor may be, for example, MnO₂, Mn, MnCl₂, or a mixture thereof. The Cu-precursor may be, for example, CuO, Cu₂O, Cu, CuCl₂, or a mixture thereof. The Ni-precursor may be, for example, NiO, Ni, NiCl₂, or a mixture thereof. The Mg-precursor may be, for example, MgO, Mg, MgCl₂, or a mixture thereof. The Fe-precursor may be, for example, Fe₂O₃, Fe, FeCl₂, or a mixture thereof. The La-precursor may be, for example, La₂O₃, LaCl₃, or a mixture thereof. The Y-precursor may be, for example, Y₂O₃.

The forming of the slurry mixture may be performed using, for example, an annular mill, a basket mill, an attrition mill, or a ball mill.

In the slurry mixture, a dispersing agent may be additionally added. As the dispersing agent, for example, an aqueous solution of a polycarboxylic acid ammonium salt, an aqueous solution of a polycarboxylic acid sodium salt, an aqueous solution of a polycarboxylic acid amine salt, or a mixture thereof may be used.

In the drying of the slurry mixture, a drying temperature may be appropriately selected according to a type of the dispersion medium used. For example, when distilled water is used as the dispersion medium, the drying temperature may be within a range from about 100° C. to about 120° C.

The drying of the slurry mixture may be performed by, for example, a spray drying. In the spray drying, the slurry mixture may be sprayed under high pressure through a nozzle into hot-wind or atmosphere, thus forming a dry granule mixture.

Calcining the dry mixture is performed to convert the dry mixture into a ferrite magnetic substance via heat treatment. In calcining the dry mixture, at least one operation may be performed from among, for example, the following operations: thermal decomposition of a component of the dry mixture, phase transfer of a component of the dry mixture, and removing a volatile component of the dry mixture.

When the calcining temperature of the dry mixture is too low, phase transfer of a component of the magnetic substance may not effectively occur. This may lead to the magnetic permeability of the formed magnetic substance being reduced because a phase other than a Y-type ferrite phase may coexist with the Y-type ferrite phase in the formed magnetic substance. On the other hand, when the calcining temperature of the dry mixture is too high, phase transfer of components of the magnetic substance may be excessive, leading to the formation of another phase. This may increase the magnetic permeability loss of the formed magnetic substance due to a phase other than a Y-type ferrite phase coexisting with the Y-type ferrite phase in the formed magnetic substance. That is, when the calcining temperature of the dry mixture is too high or too low, there is the increased possibility of forming a phase, such as an M-type ferrite phase, a Z-type ferrite phase, a W-type ferrite phase, or the like, other than the Y-type ferrite phase, which is represented by Formula 1. Such other phases may serve as an interfering factor in implementing a high magnetic permeability and a low magnetic permeability loss. The calcining temperature of the dry mixture may be within a range, for example, from about 800° C. to about 1,000° C.

When the calcining time is too short, thermal decomposition of components of the dry mixture, phase transfer of components of the dry mixture, and removal of volatile components from the dry mixture may not be effectively occur, and accordingly, the magnetic permeability loss may be negatively affected by the remaining impurities. On the other hand, when the calcining time is too long, productivity may be decreased. The calcining time may be within a range, for example, from about 1 hour to about 10 hours, or for example, the calcining time may be within a range from about 2 hours to about 4 hours.

The method of manufacturing the magnetic substance according to another exemplary embodiment may further include a step of forming a magnetic substance powder by milling the calcined magnetic substance after calcining the dry mixture. The magnetic substance in a powder form may be directly added to a later manufacturing process of a composite material for antennas. An average particle size of the magnetic substance powder may be within a range, for example, from about 0.5 μm to about 3 μm.

The forming of the magnetic substance powder may be performed using, for example, a dry mill. The forming of the magnetic substance powder may also be performed by using, for example, a wet mill and drying. The wet mill may be performed, for example, by the same method as in the forming of the slurry mixture described above. The drying may be performed, for example, by the same method as in the drying of the slurry mixture described above.

The method of manufacturing the magnetic substance according to another exemplary embodiment may further include forming a second slurry mixture by mixing the calcined magnetic substance and silicate glass in the presence of a second dispersion medium; forming a second dry mixture by drying the second slurry mixture; forming a compressed mixture by compressing the second dry mixture; and sintering the compressed mixture.

The silicate glass may promote crystal growth of the magnetic substance during sintering (of the compressed mixture). Accordingly, by adding the silicate glass, a temperature of the sintering may be decreased. The silicate glass melts at a temperature of, for example, about 500° C. or lower. An appropriate amount of the silicate glass does not negatively affect characteristics of the magnetic substance. By adding the silicate glass and decreasing the sintering temperature, there is a decreased possibility of forming a phase, such as an M-type ferrite phase, a Z-type ferrite phase, a W-type ferrite phase, or the like, other than the Y-type ferrite phase represented by Formula 1. As mentioned above, such other phases may operate as interfering elements in implementing high magnetic permeability and low magnetic permeability loss.

As the second dispersion medium, for example, water, alcohol, or a mixture thereof may be used. The alcohol increases dispersibility and is effective in removing a solvent due to its low boiling point. The alcohol may be, for example, ethanol, propanol, butanol, pentanol, or a mixture thereof. An amount of the second dispersion medium used may be within a range, for example, from about 40 parts to about 70 parts by weight based on 100 parts by weight of a total weight of the calcined magnetic substance and the silicate glass.

The silicate glass may be, for example, silica glass, fumed silica glass, borosilicate glass, aluminosilicate glass, lithium silicate glass, potassium silicate glass, sodium silicate glass, barium silicate glass, or a mixture thereof.

When an amount of silicate glass used is too small, the sintering temperature may not be decreased. On the other hand, when the amount of silicate glass used is too large, the sintering temperature may be excessively decreased, and accordingly, an unfavorable/inappropriate phase transfer of the magnetic substance, a decrease in a resonance frequency, or production of a magnetic substance having a high magnetic permeability loss may occur. The amount of silicate glass used may be within a range, for example, from about 0.5 parts to about 5 parts by weight based on 100 parts by weight of the calcined magnetic substance.

The mixing of the calcined magnetic substance and the silicate glass may be performed using, for example, an annular mill, a basket mill, an attrition mill, or a ball mill.

In the mixing of the magnetic substance and the silicate glass, a dispersing agent may be additionally added. As the dispersing agent, for example, an aqueous solution of a polycarboxylic acid ammonium salt, an aqueous solution of a polycarboxylic acid sodium salt, an aqueous solution of a polycarboxylic acid amine salt, or a mixture thereof may be used.

In the mixing of the calcined magnetic substance and the silicate glass, a bonding agent may be additionally added. The bonding agent bonds the calcined magnetic substance and the silicate glass. The bonding agent may be, for example, polyvinylalcohol, polyvinylbutyral, or a mixture thereof.

The bonding agent may promote the formation of the calcined magnetic substance and the silicate glass into a spherical granule. When the calcined magnetic substance and the silicate glass form a spherical granule, the flowability and moldability of particles of the calcined magnetic substance and the silicate glass may be drastically improved during the later compressing of the second dry mixture. An amount of the bonding agent used may be within a range of, for example, about 0.5 parts to about 5 parts by weight based on 100 parts by weight of the total weight of the calcined magnetic substance and the silicate glass.

In the drying of the second slurry mixture, the drying temperature may be appropriately selected according to a type of the second dispersion medium used therein. For example, when water is used as the second dispersion medium, the drying temperature may be within a range of, for example, from about 100° C. to about 120° C. The drying of the second slurry mixture may be performed using, for example, a spray drying. In the spray drying, a dry granular mixture may be formed by spraying the secondary slurry mixture at high pressure in hot-wind or air via a nozzle.

In the mixing of the calcined magnetic substance and the silicate glass, when the bonding agent is additionally added, removing the bonding agent through heat treatment may be further performed after the drying of the secondary slurry mixture and before the compressing of the secondary dry mixture. The temperature at which the bonding agent may be removed may be within the range of, for example, from about 240° C. to about 450° C. A time duration of the heat treatment to remove the bonding agent may be within the range of, for example, from about 2 hours to about 15 hours.

Compressing the dry mixture may bring the magnetic substance and the silicate glass into much closer contact with each other. In this way, the density of the dry mixture may be controlled. Compressing the dry mixture may be done by using, for example, a compression molding method. That is, the dry mixture may be added to any mold and a pressure induced thereto. The compression pressure may be within a range of, for example, from about 700 kg/cm² to about 1,200 kg/cm². Compressing the dry mixture may promote the formation of a pure Y-type hexagonal ferrite in the sintering step in the calcined magnetic substance.

In sintering the compressed mixture, the calcined magnetic substance forms a Y-type hexagonal ferrite, which is the final desirable crystal structure, through heat treatment.

By maintaining the sintering temperature within an appropriate range, the purity of the Y-type hexagonal ferrite in the calcined magnetic substance may be maximized, and as a result, the magnetic permeability loss due to impurities may be minimized. By using silicate glass, the sintering temperature may be decreased to, for example, about 1,250° C. or lower. In this case, the sintering temperature may be, for example, about 1,100° C. to about 1,250° C. The sintering time may be within the range of, for example, from about 1 hour to about 10 hours. The sintering of the compressed mixture may be repeated twice or more with a cooling process therebetween.

The method of manufacturing the magnetic substance including silicate glass according to another exemplary embodiment may further include forming a silicate glass-containing magnetic substance powder by milling a sintered silicate glass-contained magnetic substance after the sintering of the compressed mixture. Silicate glass-containing magnetic substance in a powder form may be directly added in a later manufacturing step for a composite material for antennas. An average particle size of the silicate glass-contained magnetic substance powder may be within a range, for example, from about 1 μm to about 5 μm.

Formation of the silicate glass-containing magnetic substance powder may be performed using, for example, a dry mill. The dry mill may be performed using, for example, a disk mill.

A composite material for antennas according to an exemplary embodiment includes a thermoplastic polymer resin matrix; and a magnetic substance powder dispersed in the matrix, the powder including a compound represented by Formula 1 below:

Ba₂₋ₚSrₚCO_{2-y-z}Zn_{y}M¹_{z}Fe_{12-q}M²_{q}O₂₂, <Formula 1>

Here, M¹ is at least one element selected from the group consisting of Mn, Cu, Ni, and Mg, M² is at least one element selected from the group consisting of La and Y, p is from about 0 to about 1, y is from about 0.1 to about 0.9, z is from about 0 to about 0.8, and q is from about 0 to about 1.

Alternatively, in Formula 1, z may be from about 0.1 to about 0.4.

An exemplary embodiment of the composite material for antennas may have a relative magnetic permeability of about 1.5 or greater or a relative magnetic permeability within a range from about 2 to about 3.5 over the entire bandwidth of 100 MHz to 3 GHz.

Also, an exemplary embodiment of the composite material for antennas may have, for example, a magnetic permeability loss of about 0.2 or less, or a magnetic permeability loss within a range from about 0.05 to about 0.1 over the entire bandwidth of 100 MHz to 3 GHz.

The thermoplastic polymer resin may be, for example, polycarbonate, polyphenylene oxide, polyphenylene ether, polycarbonate-acrilonitrile/butadiene/styrene (PC-ABS resin), or a mixture thereof.

If the average particle size of the magnetic substance powder including the compound represented by Formula 1 is too small, it may be difficult to obtain a high magnetic permeability. On the other hand, if the average particle size of the magnetic substance powder is too big, magnetic permeability loss may be excessive. The average particle size of the magnetic substance powder may be within a range, for example, from about 0.5 μm to about 5 μm, or from about 1 μm to about 3 μm.

The magnetic substance powder may further include silicate glass. The silicate glass may be, for example, silica glass, fumed silica glass, borosilicate glass, aluminosilicate glass, lithium silicate glass, potassium silicate glass, sodium silicate glass, barium silicate glass, or a mixture thereof. An amount of the silicate glass may be within a range, for example, from about 0.5 parts to about 5 parts by weight based on 100 parts by weight of the compound represented by Formula 1.

If an amount of the magnetic substance powder in the composite material for antennas is too small, it may be difficult to achieve antenna miniaturization and broadband communication since the value of the magnetic permeability is too low. On the other hand, if the amount of the magnetic substance powder in the composite material for antennas is too large, the composite material may not be suitable for use in an antenna since a radiation efficiency of the antenna decreases due to an increase of magnetic permeability loss, and drop reliability or the like may deteriorate since injection-moldability is worsened. An amount of the magnetic substance powder in the composite material for antennas may be within the range of, for example, from about 40 wt % to about 80 wt %.

The magnetic substance powder may be surface treated with a coupling agent in order to strengthen the adhesive strength between the magnetic substance powder and the thermoplastic polymer resin. The coupling agent may be, for example, a silane-based coupling agent, a titanate-based coupling agent, an aluminate-based coupling agent, a zirconate-based coupling agent, or a mixture thereof.

The composite material for antennas may be manufactured by, for example, mixing the melted thermoplastic polymer resin and the magnetic substance powder using an extruder, cooling a mixture of the melted thermoplastic polymer resin and the magnetic substance powder, and milling or cutting the cooled mixture. Accordingly, the composite material for antennas may have a form of a powder or a pellet.

The composite material for antennas may be easily molded according to a typical plastic molding method. In this regard, an antenna carrier having a desired size and shape may be conveniently obtained by using the composite material for antennas according to an exemplary embodiment.

Another exemplary embodiment of an antenna includes an antenna carrier formed of a composite material for antennas including a thermoplastic polymer resin matrix and a magnetic substance powder dispersed in the matrix, the powder including a compound represented by Formula 1 below; and a resonance circuit pattern formed on a surface of the antenna carrier:

Ba₂₋ₚSrₚCO_{2-y-z}Zn_{y}M¹_{z}Fe_{12-q}M²_{q}O₂₂, <Formula 1>

Here, M¹ is at least one element selected from the group consisting of Mn, Cu, Ni, and Mg, M² is at least one element selected from the group consisting of La and Y, p is from about 0 to about 1, y is from about 0.1 to about 0.9, z is from about 0 to about 0.8, and q is from about 0 to about 1.

Alternatively, in Formula 1, z may be from about 0.1 to about 0.4.

The magnetic substance powder of the antenna carrier may further include silicate glass.

If an average particle size of the magnetic substance powder is too small, it may be difficult to obtain a high magnetic permeability. On the other hand, if the average particle size of the magnetic substance powder is too big, the magnetic permeability loss may become too high. The average particle size of the magnetic substance powder may be within the range of, for example, from about 0.5 μm to about 5 μm, or from about 1 μm to about 3 μm.

The shape and size of the antenna carrier is not particularly limited and may be freely selected according to design specifications of the antenna or as desired.

The antenna carrier affects a resonance property of the resonance circuit pattern and also serves as a support to support the resonance circuit pattern. An exemplary embodiment of the antenna carrier may improve the resonance efficiency of the resonance circuit pattern by having a high magnetic permeability and a low magnetic permeability loss. Further, since the antenna carrier has a high magnetic permeability and a low magnetic permeability loss at a high frequency, the antenna carrier may improve the resonance efficiency of the resonance circuit pattern even at a high frequency. Moreover, since the antenna carrier has a high magnetic permeability and a low magnetic permeability loss, the antenna carrier may induce the resonance circuit pattern to have an excellent resonance efficiency even if the size of the antenna carrier is small. Accordingly, an exemplary embodiment of the antenna may be effectively used as a compact internal antenna.

The resonance circuit pattern may include an electrically conductive material such as, for example, Ag, Pd, Pt, Cu, Au, Ni, or a mixture thereof. The resonance circuit pattern may be formed on a surface of the antenna carrier by, for example, printing, photo-printing, plating, vapor depositing, sputtering, gluing, or mechanical fixing. For example, the resonance circuit pattern may include at least one horizontal composition circuit and at least one vertical composition circuit that may be divided by at least one meandering portion. The resonance circuit pattern may be, for example, a meander type, a spiral type, a step type, a loop type, or a combination thereof.

The antenna may have, for example, an inverted L antenna (ILA) structure, an inverted F antenna (IFA) structure, or a monopole antenna structure.

The following are exemplary embodiments, and should not be understood to limit the scope of the present disclosure.

### EXAMPLES

### Example 1

### Manufacturing Ba₂Co₁Zn_{0.7}Cu_{0.15}Mn_{0.15}Fe₁₂O₂₂ (Sintering Temperature: 1,100° C.)

7,000 g of distilled water as a dispersion medium, 4,420 g of iron oxide (Fe₂O₃), 1,813 g of barium carbonate (BaCO₃), 374 g of cobalt oxide (Co₃O₄), 263 g of zinc oxide (ZnO), 56 g of copper oxide (CuO), and 75 g of manganese oxide (MnO₂) were mixed at 2,000 rpm for 3 hours using an annular mill (manufactured by Nanointech Co.), and thus a first slurry mixture was obtained.

The first slurry mixture was dried using a spray dryer (manufactured by Dong Jin Technology Institute Co., Spray Dryer, DJE-003R) at a temperature of 220° C., and thus a first dry granular mixture was obtained.

The first dry granular mixture was calcined in an electric furnace at a temperature of 1,000° C. for 3 hours, and thus a magnetic substance having a composition of Ba₂Co₁Zn_{0.7}Cu_{0.15}Mn_{0.15}Fe₁₂O₂₂ was obtained.

6,000 g of the calcined magnetic substance, 6,000 g of distilled water, and 60 g of silicate glass (weight ratio of silicon dioxide:boron oxide:lithium oxide:potassium oxide:barium oxide=11:4:3:1:1) were milled and mixed at 2,000 rpm for 3 hours using an annular mill (manufactured by Nanointech Co.), and thus a second slurry mixture was obtained.

The second slurry mixture was dried using a spray dryer (manufactured by Dong Jin Technology Institute Co., DJE-003R) at a temperature of 220° C., and thus a second dry granular mixture was obtained.

The second dry granular mixture was compression molded at a pressure of 1,200 kg_{f}/cm².

The compressed second dry granular mixture was sintered in an electric furnace at a temperature of 1,100° C. for 3 hours, and thus a silicate glass-containing magnetic substance was obtained.

The sintered silicate glass-containing magnetic substance was dry milled at 500 rpm for 6 hours using a disk mill (manufactured by Nanointech Co.), and thus a silicate glass-containing magnetic substance powder was obtained. The average particle size of the silicate glass-containing magnetic substance powder was 3 μm.

### Example 2

### Manufacturing Ba₂Co₁Zn_{0.7}Cu_{0.15}Mn_{0.15}Fe₁₂O₂₂ (Sintering Temperature: 1,150° C.)

A silicate glass-containing magnetic substance powder was obtained in the same manner as in Example 1, except that the sintering temperature was 1,150° C. instead of 1,100° C.

### Example 3

### Manufacturing Ba₂Co₁Zn_{0.7}Cu_{0.15}Mn_{0.15}Fe₁₂O₂₂ (Sintering Temperature: 1,200° C.)

A silicate glass-containing magnetic substance powder was obtained in the same manner as in Example 1, except that the sintering temperature was 1,200° C. instead of 1,100° C.

### Example 4

### Manufacturing Ba₂Co₁Zn_{0.7}Cu_{0.15}Mn_{0.15}Fe₁₂O₂₂ (Sintering Temperature: 1,250° C.)

A silicate glass-containing magnetic substance powder was obtained in the same manner as in Example 1, except that the sintering temperature was 1,250° C. instead of 1,100° C.

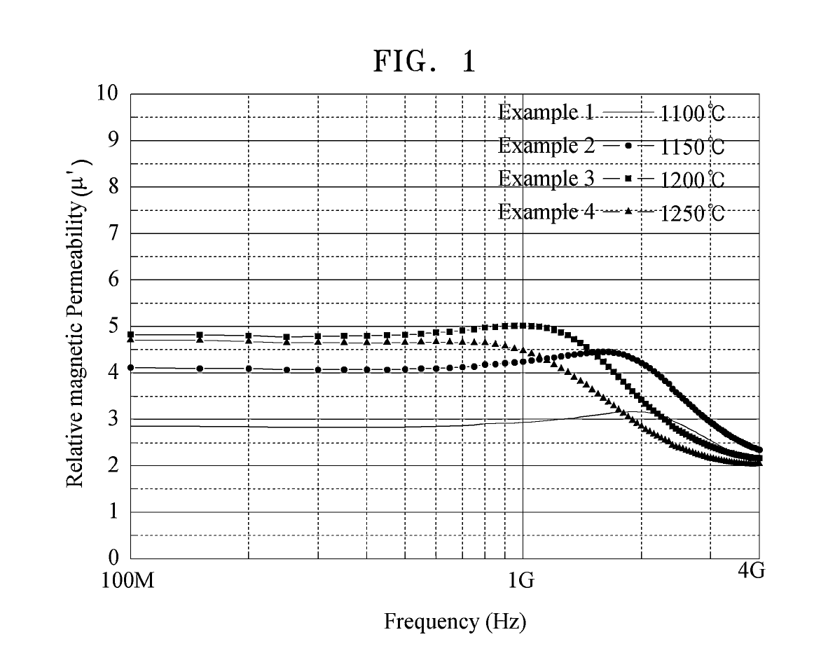

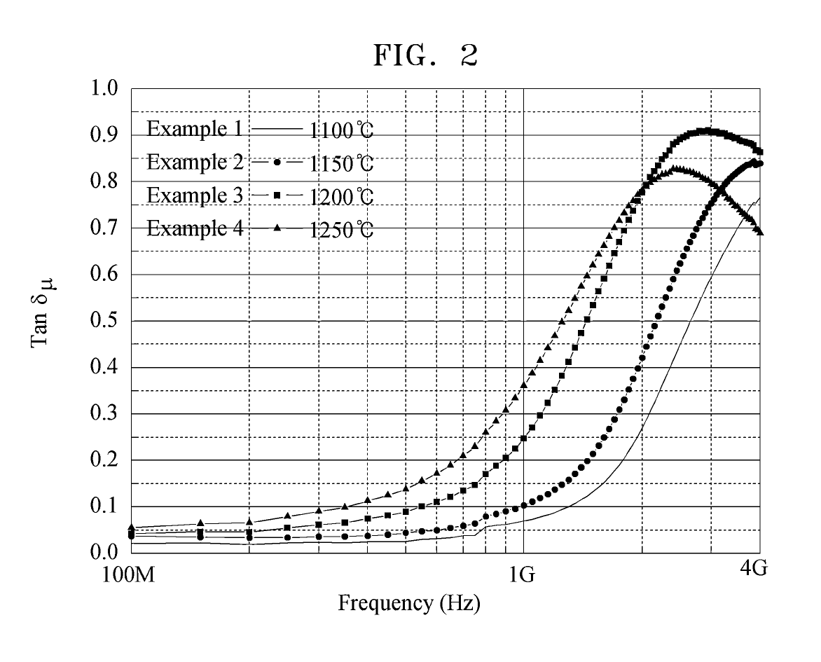

FIG. 1 shows the result of a change in the relative magnetic permeability of the magnetic substance powders of Examples 1 to 4 according to frequency. FIG. 2 shows the result of a change in a magnetic permeability loss of the magnetic substance powders of Examples 1 through 4 measured in regard to frequency. The relative magnetic permeability and the magnetic permeability loss were measured according to a coaxial line method by using an instrument (manufactured by Agilent Technologies, E5071 network).

As shown in FIG. 1, the magnetic substance powders of Examples 1 through 4 have a relative magnetic permeability (μᵣ) within a range from 2 to 5 over the entire bandwidth of 100 MHz through 3 GHz. Also as shown in FIG. 2, the magnetic substance powders of Examples 1 through 4 have a magnetic permeability loss (Tan δ_{μ}) within a range of from 0 to 0.9 over the entire bandwidth of 100 MHz through 3 GHz.

The fact that the relative magnetic permeability (μᵣ) was 2 or greater and the magnetic permeability loss (Tan δ_{μ}) was 0.9 or less over the entire bandwidth of 100 MHz through 3 GHz indicates that exemplary embodiments of the magnetic substance may induce an excellent resonance efficiency over a very wide frequency bandwidth.

Particularly, the magnetic substance powder of Example 2 (a sintering temperature 1,150° C.) exhibited a very high performance with a relative magnetic permeability of 4.2 and a magnetic permeability loss of 0.42 at 2 GHz.

### Example 5

### Manufacturing Ba₂Co₁Zn_{0.7}Cu_{0.3}Fe₁₂O₂₂ (Sintering Temperature: 1,150° C.)

7,000 g of distilled water as a dispersion medium, 4,420 g of Fe₂O₃, 1,813 g of BaCO₃, 374 g of Co₃O₄, 263 g of ZnO, and 112 g of CuO were mixed at 2,000 rpm for 3 hours using an annular mill (manufactured by Nanointech Co.), and a thus first slurry mixture was obtained. A silicate glass-containing magnetic substance powder was obtained in the same manner as in Example 2, except that the first slurry mixture obtained here is used.

### Example 6

### Manufacturing Ba₂Co₁Zn_{0.7}Mn_{0.3}Fe₁₂O₂₂ (Sintering Temperature: 1,150° C.)

7,000 g of distilled water as a dispersion medium, 4,420 g of Fe₂O₃, 1,813 g of BaCO₃, 374 g of Co₃O₄, 263 g of ZnO, and 150 g of MnO₂ were mixed at 2,000 rpm for 3 hours using an annular mill (manufactured by Nanointech Co.), and thus a first slurry mixture was obtained. A silicate glass-containing magnetic substance powder was obtained in the same manner as in Example 2, except that the first slurry mixture obtained here is used.

### Example 7

### Manufacturing Ba_{1.5}Sr_{0.5}Co₁Zn_{0.7}Cu_{0.15}Mn_{0.15}Fe₁₂O₂₂ (Sintering Temperature: 1,150° C.)

7,000 g of distilled water as a dispersion medium, 4,420 g of Fe₂O₃, 1,364 g of BaCO₃, 345 g of a strontium carbonate (SrCO₃), 374 g of Co₃O₄, 263 g of ZnO, 56 g of CuO, and 75 g of MnO₂ were mixed at 2,000 rpm for 3 hours using an annular mill (manufactured by Nanointech Co.), and thus a first slurry mixture was obtained. A silicate glass-containing magnetic substance powder was obtained in the same manner as in Example 2, except that the first slurry mixture obtained here is used.

### Example 8

### Manufacturing Ba₂Co₁Zn_{0.7}Cu_{0.15}Mn_{0.15}Fe_{11.5}Y_{0.5}O₂ (Sintering Temperature: 1,150° C.)

7,000 g of distilled water as a dispersion medium, 4,190 g of Fe₂O₃, 1,813 g of BaCO₃, 374 g of Co₃O₄, 263 g of ZnO, 56 g of CuO, 75 g of MnO₂, and 257 g of yttrium oxide (Y₂O₃) were mixed at 2,000 rpm for 3 hours using an annular mill (manufactured by Nanointech Co.), and thus a first slurry mixture was obtained. A silicate glass-containing magnetic substance powder was obtained in the same manner as in Example 2, except that the first slurry mixture obtained here is used.

Measured values of the relative magnetic permeability, the magnetic permeability loss, the relative dielectric permittivity, and the dielectric loss of each of the magnetic substance powders of Examples 2 and 5 to 8 at 2 GHz are summarized in Table 1.

TABLE 1

| | | Relative | Magnetic | Relative | |
|---|---|---|---|---|---|
| | Formula of Magnetic | magnetic | permeability | dielectric | Dielectric |
| Sample | substance | permeability | loss | permittivity | loss |
| Example 2 | Ba₂Co₁Zn_{0.7}Cu_{0.15}Mn_{0.15}Fe₁₂O₂₂ | 4.21 | 0.42 | 12.7 | 0.006 |
| Example 5 | Ba₂Co₁Zn_{0.7}Cu_{0.3}Fe₁₂O₂₂ | 4.39 | 0.78 | 13.2 | 0.009 |
| Example 6 | Ba₂Co₁Zn_{0.7}Mn_{0.3}Fe₁₂O₂₂ | 3.87 | 0.52 | 14.3 | 0.039 |
| Example 7 | Ba_{1.5}Sr_{0.5}Co₁Zn_{0.7}Cu_{0.15}Mn_{0.15}Fe₁₂O₂₂ | 4.14 | 0.34 | 12.6 | 0.005 |
| Example 8 | Ba₂Co₁Zn_{0.7}Cu_{0.15}Mn_{0.15}Fe_{11.5}Y_{0.5}O₂₂ | 3.58 | 0.37 | 11.17 | 0.007 |

### Example 9

### Manufacturing of Composite Material for Antennas (PC; Magnetic Substance 43 wt %)

1,000 g of the silicate glass-containing magnetic substance powder obtained in Example 2, 1,300 g of polycarbonate (PC, manufactured by Cheil Industries Inc., HF-10231M), and 10 g of coupling agent (manufactured by Sila-Ace, S-530) were melt-mixed using a melt extruder (manufactured by Bautek, Twin Extruder). Here, the melting temperature of the polycarbonate was 240° C.

The melt-mixed resultant was cooled and cut to form pellets having a diameter of 5 mm. The pellets are the composite material for antennas of Example 9.

### Example 10

### Manufacturing of Composite Material for Antennas (PC; Magnetic Substance 58 wt %)

A composite material for antennas was obtained in the same manner as in Example 9, except that 1,000 g of the silicate glass-containing magnetic substance powder obtained in Example 2 and 720 g of the polycarbonate were used.

### Example 11

### Manufacturing of Composite Material for Antennas (PC; Magnetic Substance 73 wt %)

A composite material for antennas was obtained in the same manner as in Example 9, except that 1,000 g of the silicate glass-containing magnetic substance powder obtained in Example 2 and 360 g of the polycarbonate were used.

### Example 12

### Manufacturing of Composite Material for Antennas (PC; Magnetic Substance 76 wt %)

A composite material for antennas was obtained in the same manner as in Example 9, except that 1,000 g of the silicate glass-containing magnetic substance powder obtained in Example 2 and 300 g of the polycarbonate were used.

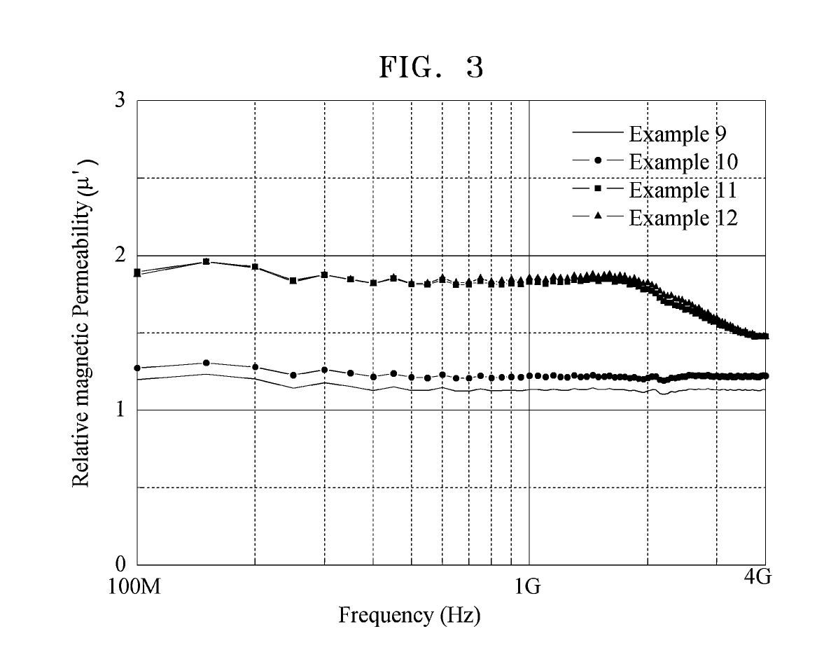

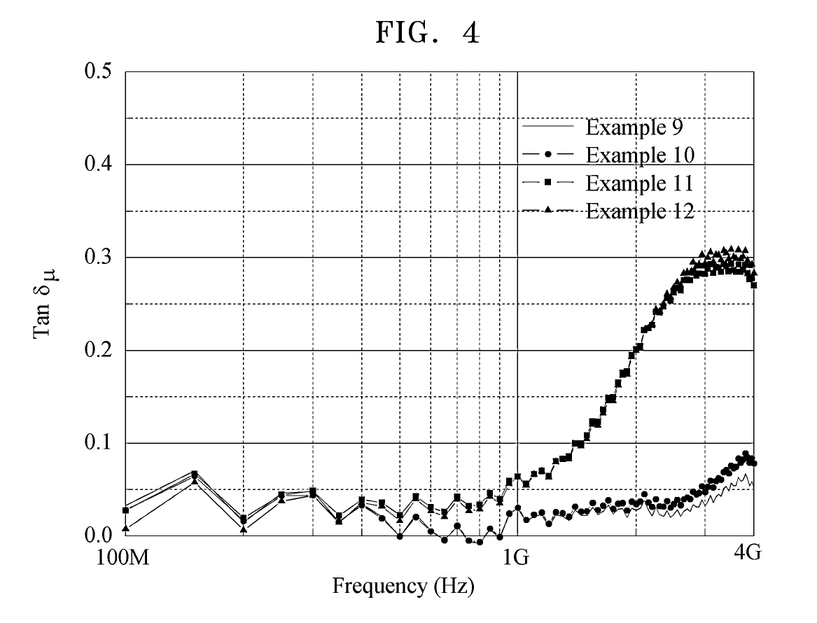

FIG. 3 shows the result of a change in the relative magnetic permeability of the composite materials for antennas of Examples 9 through 12 measured in regard to frequency. FIG. 4 shows the result of a change in a magnetic permeability loss of the composite materials for antennas of Examples 9 through 12 in regard to frequency.

As shown in FIG. 3, the composite materials for antennas of Examples 9 through 12 have a relative magnetic permeability (μᵣ) of 1.4 or greater over the entire bandwidth of 100 MHz through 3 GHz. Also as shown in FIG. 4, the composite materials for antennas of Examples 9 through 12 have a magnetic permeability loss (Tan δ_{μ}) of 0.3 or less over the entire bandwidth of 100 MHz through 3 GHz.

The fact that the relative magnetic permeability (μᵣ) was 1.4 or greater and the magnetic permeability loss (Tan δ_{μ}) was 0.3 or less over the entire bandwidth of 100 MHz through 3 GHz indicates that the composite material for exemplary embodiments of antennas may induce an excellent resonance efficiency over a very wide frequency bandwidth.

The relative magnetic permeability (μᵣ) and the magnetic permeability loss (Tan δ_{μ}) of each of the composite materials for antennas of Examples 9 through 12 at 2 GHz are summarized in Table 2.

TABLE 2

| | Content of magnetic | Relative | Magnetic |
|---|---|---|---|
| | substance powder | magnetic | permeability |
| Sample | (wt %) | permeability | loss |
| Example 9 | 43 | 1.12 | 0.02 |
| Example 10 | 58 | 1.41 | 0.09 |
| Example 11 | 73 | 1.78 | 0.20 |
| Example 12 | 76 | 1.82 | 0.21 |

As shown in Table 2, the relative magnetic permeability increased as the content of the magnetic substance increased. Also, the relative magnetic permeability of the composite materials for antennas of Examples 11 and 12, in which concentrations of the magnetic substance were respectively 73 wt % and 76 wt %, increased significantly compared to that of the composite materials for antennas of Examples 9 and 10 of which concentrations of the magnetic substance were respectively 43 wt % and 58 wt %.

Also, when the concentration of the magnetic substance exceeds 80 wt %, a further increase of the relative magnetic permeability was insignificant.

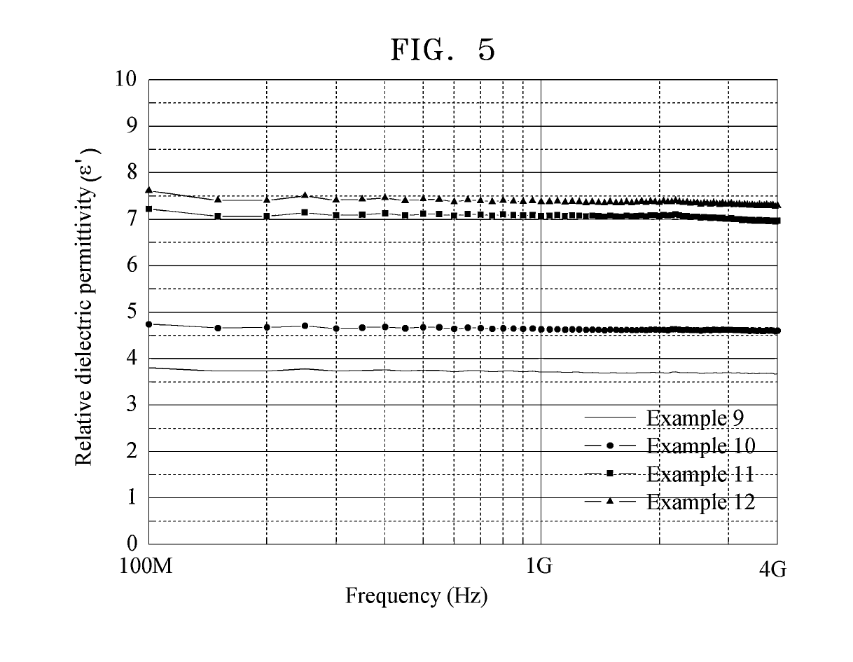

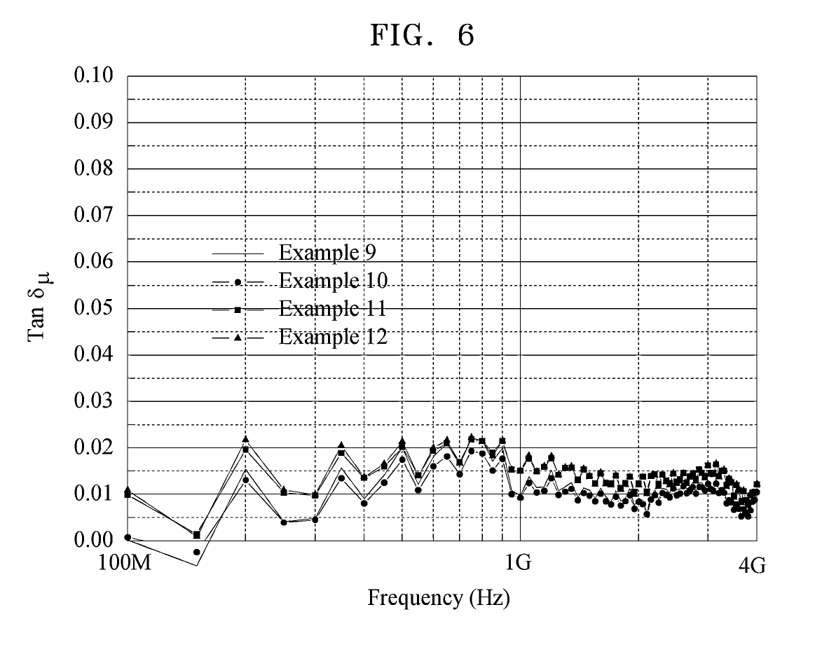

FIG. 5 shows a result of a change in the relative dielectric permittivity of the composite materials for antennas of Examples 9 through 12 measured in regard to frequency. FIG. 6 shows a result of a change in a dielectric loss of the composite materials for antennas of Examples 9 through 12 measured in regard to frequency.

As shown in FIG. 5, the composite materials for antennas of Examples 9 through 12 have a relative dielectric permittivity (∈ᵣ) of 3 or greater over the entire bandwidth of 100 MHz through 3 GHz. Also, as shown in FIG. 6, the composite materials for antennas of Examples 9 through 12 have a dielectric loss (Tan δ_{∈}) of 0.01 or less over the entire bandwidth of 100 MHz through 3 GHz.

The relative dielectric permittivity (∈ᵣ) and the dielectric loss (Tan δ_{∈}) of each of the composite materials for antennas of Examples 9 through 12 at 2 GHz are summarized in Table 3.

TABLE 3

| | Concentration of | Relative | |
|---|---|---|---|
| | magnetic substance | dielectric | Dielectric |
| Sample | powder (wt %) | permittivity | loss |
| Example 9 | 43 | 3.69 | 0.009 |
| Example 10 | 58 | 4.01 | 0.009 |
| Example 11 | 73 | 7.08 | 0.012 |
| Example 12 | 76 | 7.38 | 0.012 |

As shown in Table 3, the relative dielectric permittivity increased as the concentration of the magnetic substance increased. Also, the relative dielectric permittivity of the composite materials for antennas of Examples 11 and 12, in which concentrations of the magnetic substance were respectively 73 wt % and 76 wt %, increased significantly compared to the composite materials for antennas of Examples 9 and 10, in which concentrations of the magnetic substance were respectively 43 wt % and 58 wt %.

### Example 13

### Manufacturing of Composite Material for Antennas (PC; Magnetic Substance 43 wt %)

A composite material for antennas was obtained in the same manner as in Example 9, except that the silicate glass-containing magnetic substance powder (Ba₂Co₁Zn_{0.7}Cu_{0.3}Fe₁₂O₂₂) obtained in Example 5 was used.

### Example 14

### Manufacturing of Composite Material for Antennas (PC; Magnetic Substance 43 Wt %)

A composite material for antennas was obtained in the same manner as in Example 9, except that the silicate glass-containing magnetic substance powder (Ba_{1.5}Sr_{0.5}Co₁Zn_{0.7}Cu_{0.15}Mn_{0.15}Fe₁₂O₂₂) obtained in Example 7 was used.

Measured values of the relative magnetic permeability, the magnetic permeability loss, the relative dielectric permittivity, and the dielectric loss of each of the composite materials for antennas of Examples 13 and 14 at 2 GHz are summarized in Table 4. Also, measured values of the relative magnetic permeability, the magnetic permeability loss, the relative dielectric permittivity, and the dielectric loss of the composite material for antennas of Example 10 are shown in Table 4.

TABLE 4

| | | Relative | Magnetic | Relative | |
|---|---|---|---|---|---|
| | Formula of magnetic | magnetic | permeability | dielectric | Dielectric |
| Sample | substance | permeability | loss | permittivity | loss |
| Example | Ba₂Co₁Zn_{0.7}Cu_{0.15}Mn_{0.15}Fe₁₂O₂₂ | 1.41 | 0.09 | 4.01 | 0.009 |
| 10 | | | | | |
| Example | Ba₂Co₁Zn_{0.7}Cu_{0.3}Fe₁₂O₂₂ | 1.41 | 0.14 | 4.39 | 0.01 |
| 13 | | | | | |
| Example | Ba_{1.5}Sr_{0.5}Co₁Zn_{0.7}Cu_{0.15}Mn_{0.15}Fe₁₂O₂₂ | 1.46 | 0.10 | 4.28 | 0.009 |
| 14 | | | | | |

### Example 15

### Manufacturing of Composite Material for Antennas (PPO; Magnetic Substance 43 wt %)

A composite material for antennas was obtained in the same manner as in Example 9, except that 960 g of polyphenylene oxide (PPO) (manufactured by Sabic Co. NORYL) was used instead of the polycarbonate, and 1,000 g of the silicate glass-containing magnetic substance powder obtained in Example 2 was used.

### Example 16

### Manufacturing of Composite Material for Antennas (PPO; Magnetic Substance 68 wt %)

A composite material for antennas was obtained in the same manner as in Example 9, except that 450 g of polyphenylene oxide (PPO, manufactured by Sabic Co. NORYL) was used instead of the polycarbonate, and 1,000 g of the silicate glass-containing magnetic substance powder obtained in Example 2 was used.

### Example 17

### Manufacturing of Composite Material for Antennas (PPE; Magnetic Substance 50 wt %)

A composite material for antennas was obtained in the same manner as in Example 9, except that 960 g of polyphenylene ether (PPE, manufactured by Cheil Industries Inc., HR-8070) was used instead of the polycarbonate, and 1,000 g of the silicate glass-containing magnetic substance powder obtained in Example 2 was used.

### Example 18

### Manufacturing of Composite Material for Antennas (PPE; Magnetic Substance 68 wt %)

A composite material for antennas was obtained in the same manner as in Example 9, except that 450 g of polyphenylene ether (PPE, manufactured by Cheil Industries Inc., HR-8070) was used instead of the polycarbonate, and 1,000 g of the silicate glass-containing magnetic substance powder obtained in Example 2 was used.

### Example 19

### Manufacturing of Composite Material for Antennas (PC-ABS; Magnetic Substance 50 Wt %)

A composite material for antennas was obtained in the same manner as in Example 9, except that 960 g of PC-ABS (manufactured by Cheil Industries Inc., HR-8070) was used instead of the polycarbonate, and 1,000 g of the silicate glass-containing magnetic substance powder obtained in Example 2 was used.

### Example 20

### Manufacturing of Composite Material for Antennas (PC-ABS; Magnetic Substance 68 wt %)

A composite material for antennas was obtained in the same manner as in Example 9, except that 450 g of PC-ABS (manufactured by Cheil Industries Inc., HR-8070) was used instead of the polycarbonate, and 1,000 g of the silicate glass-containing magnetic substance powder obtained in Example 2 was used.

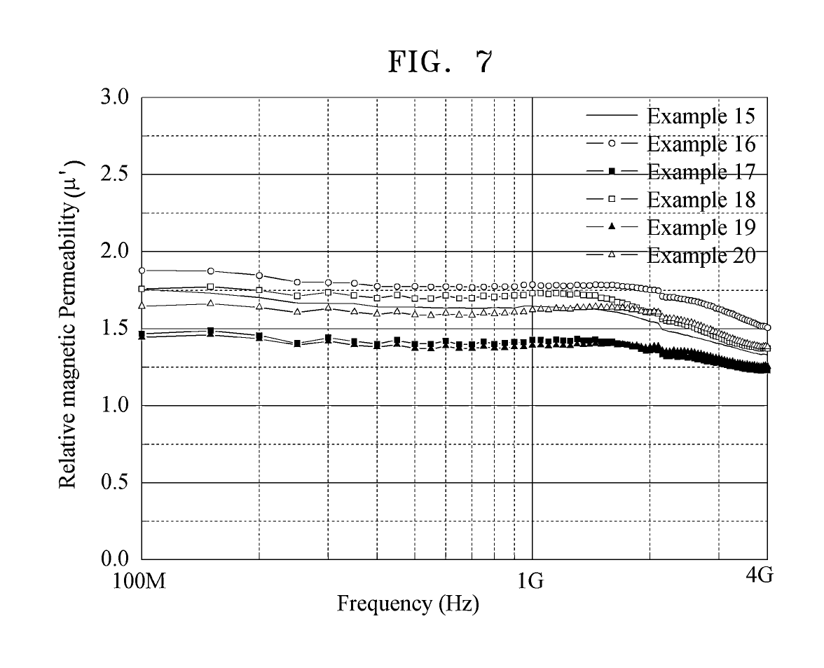

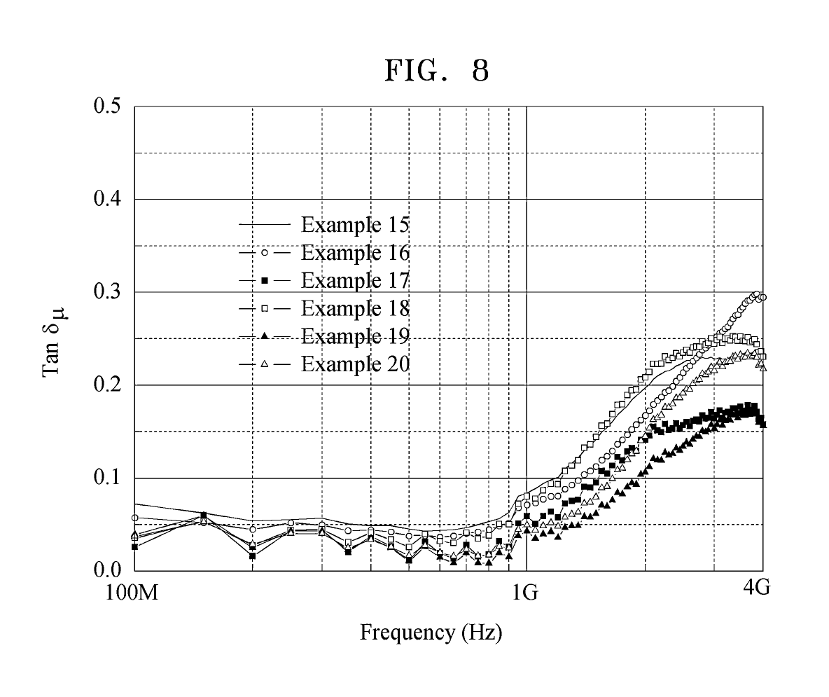

FIG. 7 shows the result of a change in the relative magnetic permeability of the composite materials for antennas of Examples 15 through 20 measured in regard to frequency. FIG. 8 shows a result of a change in the magnetic permeability loss of the composite materials for antennas of Examples 15 through 20 measured in regard to frequency.

As shown in FIG. 7, the composite materials for antennas of Examples 15 through 20 have a relative magnetic permeability (μᵣ) of 1.4 or greater over the entire bandwidth of 100 MHz through 3 GHz. A tendency of the relative magnetic permeability to increase according to an increase of a concentration of the magnetic substance is also observed in FIG. 7.

Also, as shown in FIG. 8, the composite materials for antennas of Examples 15 through 20 have a magnetic permeability loss (Tan δμ) of 0.3 or less over the entire bandwidth of 100 MHz through 3 GHz.

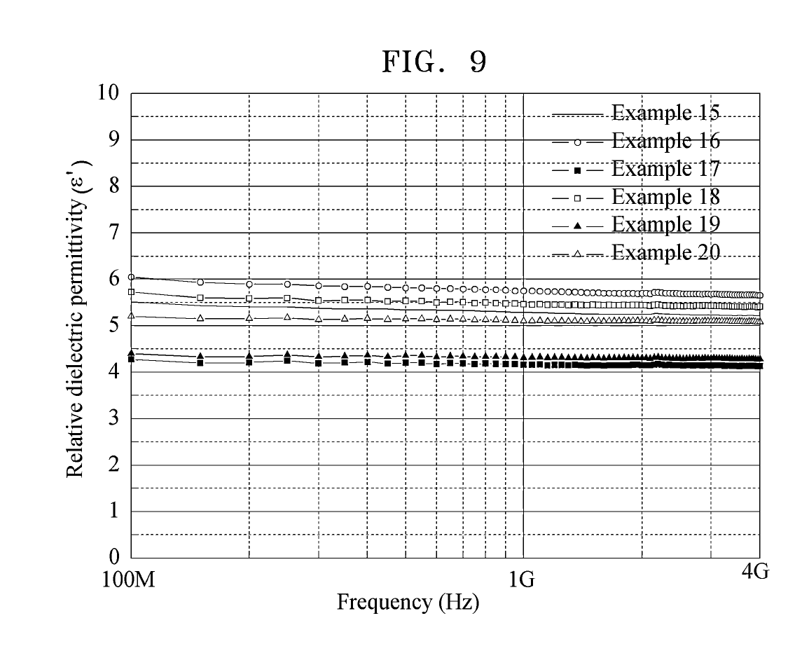

FIG. 9 shows a result of a change in the relative dielectric permittivity of the composite materials for antennas of Examples 15 through 20 measured in regard to frequency. FIG. 10 shows a result of a change in the dielectric loss of the composite materials for antennas of Examples 15 through 20 measured in regard to frequency.

As shown in FIG. 9, the composite materials for antennas of Examples 15 through 20 have a relative dielectric permittivity (∈ᵣ) of 4 or greater over the entire bandwidth of 100 MHz through 3 GHz. A tendency of the relative dielectric permittivity to increase according to an increase of the concentration of the magnetic substance was observed in FIG. 9.

Also, as shown in FIG. 10, the composite materials for antennas of Examples 15 through 20 have a dielectric loss (Tan δ_{∈}) of 0.3 or less over the entire bandwidth of 100 MHz through 3 GHz. A tendency of the dielectric loss to increase according to an increase of the concentration of the magnetic substance is observed in FIG. 10. The composite material for antennas (PC-ABS, magnetic substance 50 wt %) of Example 19 and the composite material for antennas (PC-ABS, magnetic substance 68 wt %) of Example 20 have a very low dielectric loss (Tan δ_{∈}) of 0.15 or less over the entire bandwidth of 100 MHz through 3 GHz. Also, in those cases when PC-ABS was used, the change in the dielectric loss according to the change in the concentration of the magnetic substance was observed to be very small as compared to the cases when other polymers were used over the entire bandwidth of 100 MHz through 3 GHz.

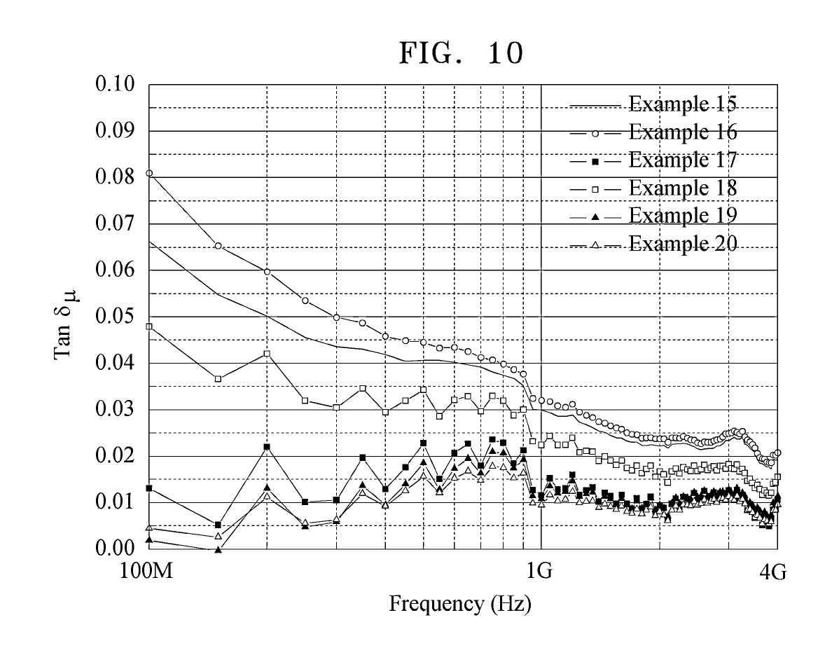

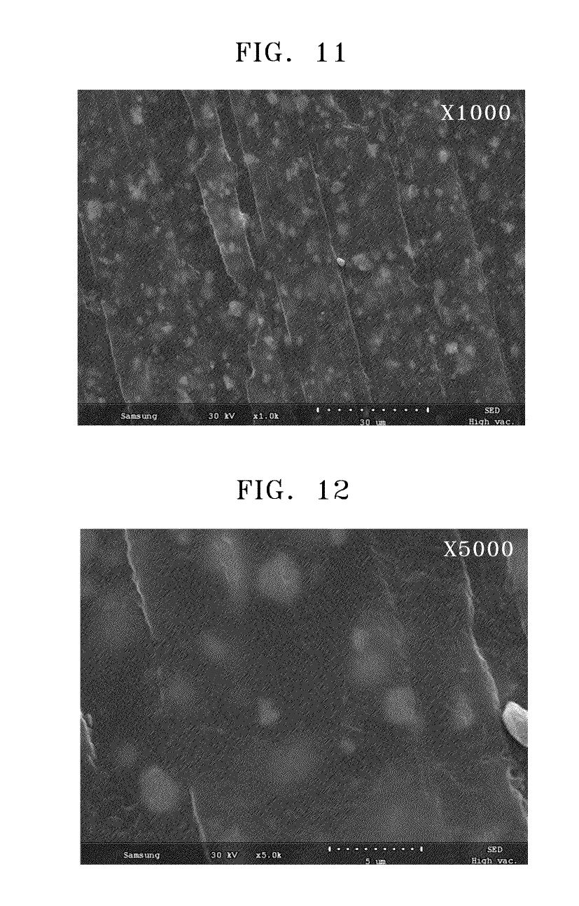

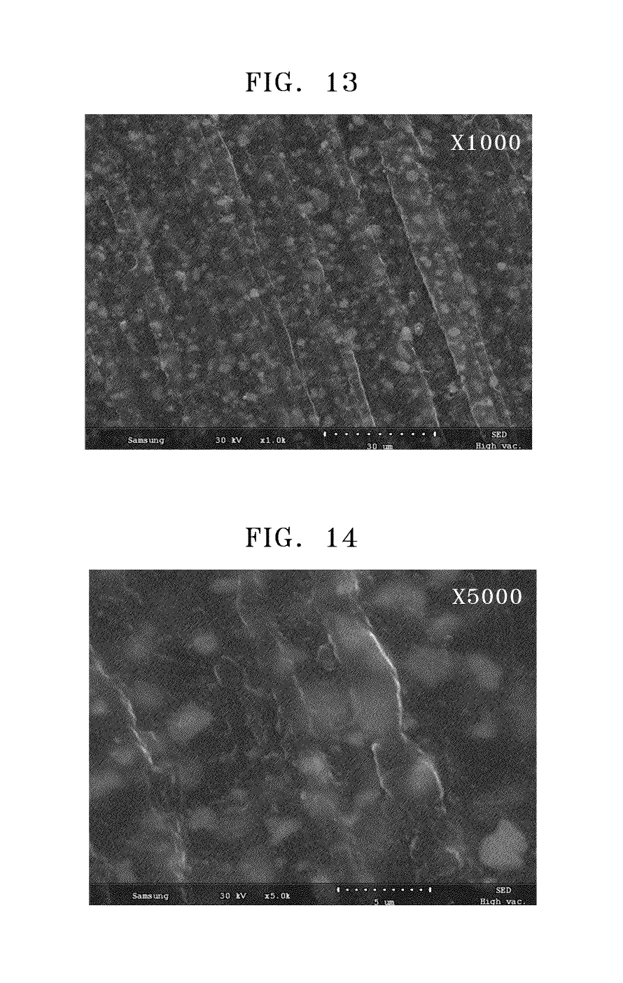

FIG. 11 is a scanning electron microscope (SEM) image (×1,000) of the composite material for antennas (PC-ABS, magnetic substance 50 wt %) of Example 19. FIG. 12 is a SEM image (×5,000) of the composite material for antennas (PC-ABS, magnetic substance 50 wt %) of Example 19. FIG. 13 is a SEM image (×1,000) of the composite material for antennas (PC-ABS, magnetic substance 68 wt %) of Example 20. FIG. 14 is a SEM image (×5,000) of the composite material for antennas (PC-ABS, magnetic substance 68 wt %) of Example 20.

As shown in FIGS. 11 through 14, more particles of the magnetic substance are present as the concentration of the magnetic substance increases. Also, the size of the particles of the magnetic substance shown in FIGS. 11 through 14 is within the range of from 1 μm to 5 μm.

### Example 21

### Manufacturing of Antenna Carrier

An antenna carrier was manufactured by using an injection molding method using the composite material for antennas (polycarbonate, magnetic substance 73 wt %) of Example 11.

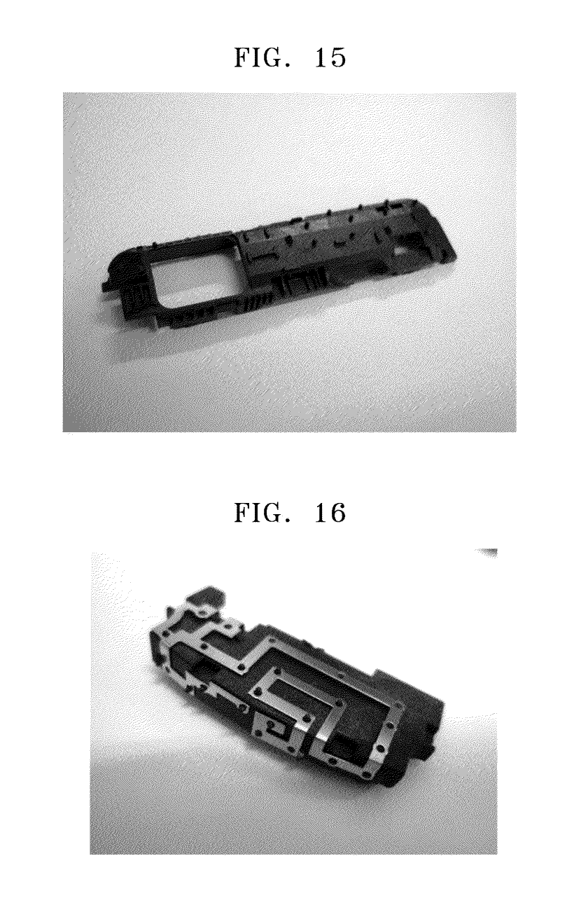

First, in order to facilitate injection molding, the composite material for antennas of Example 11 was dried in an oven at a temperature of 90° C. for 6 hours. The antenna carrier of Example 21 was manufactured by injection molding the dried composite material for antennas of Example 11 by using an injection molding machine (manufactured by FANUC Co., ROBOSHOT S-2000i). FIG. 15 is an image of the antenna carrier of Example 21.

As can be confirmed in Example 21, the composite material for antennas may be molded much like common plastic. Accordingly, the antenna carrier has not only the excellent characteristics of magnetic permeability and low magnetic permeability loss, but may also be freely molded in desired shapes and sizes. In this regard, the design dependency of a wireless communication system on the antenna carrier may be drastically lowered.

### Example 22

### Manufacturing of Antenna

First, in order to facilitate injection molding, the composite material for antennas of Example 11 was dried in an oven at a temperature of 90° C. for 6 hours. The injection molding was performed on the dried composite material for antennas of Example 11 by using an injection molding machine (manufactured by FANUC Co., ROBOSHOT S-2000i). A resonance circuit pattern was formed on a surface of the antenna carrier which was injection molded to equip bumps for fixing the resonance circuit pattern.

FIG. 16 is an image of the antenna of Example 22. Here, the resonance circuit pattern was fixed by heat-riveting the bumps for fixing the resonance circuit pattern of the antenna carrier. Of course, the fixed bumps are also formed of the composite material for antennas of Example 11. The fixed bumps were able to be very conveniently heat-riveted like common plastics.

In this regard, it may be confirmed that an exemplary embodiment of composite material for antennas may have an excellent easy-to-manufacture performance. Accordingly, by using the composite material for antennas according to an exemplary embodiment, the antenna carrier has excellent characteristics of a magnetic permeability and a magnetic permeability loss and may be freely molded in desired shapes and sizes, and thus design dependency of a wireless communication system on the antenna carrier may be drastically lowered.

The magnetic substance according to an embodiment of the present invention may induce an excellent resonance efficiency over a very wide frequency bandwidth by having a high relative magnetic permeability and a low magnetic permeability loss over a wide bandwidth of frequency. For example, the magnetic substance according to an exemplary embodiment may have a relative magnetic permeability of about 2 or greater and a magnetic permeability loss of about 0.9 or less over the entire bandwidth of 100 MHz through 3 GHz.

The composite material for antennas according to an exemplary embodiment may also induce an excellent resonance efficiency over a very wide frequency bandwidth by having a high relative magnetic permeability and a low magnetic permeability loss over a wide bandwidth of frequency. The composite material for antennas according to an embodiment of the present invention may have, for example, a relative magnetic permeability of about 2 or greater and a magnetic permeability loss of about 0.9 or less over the entire bandwidth of 100 MHz through 3 GHz. Moreover, the composite material for antennas may be molded similar to a common plastic. Accordingly, the antenna carrier has excellent characteristics of magnetic permeability and magnetic permeability loss and may be freely molded in desired shapes and sizes. In this regard, design dependency of the antenna carrier of a wireless communication system may be drastically lowered.

In addition, the antenna carrier according to an exemplary embodiment may induce a resonance circuit pattern to have an excellent resonance efficiency even when the size of the antenna carrier according to an exemplary embodiment is small. That is because the antenna carrier exhibits a high relative magnetic permeability and a low magnetic permeability loss. Accordingly, the antenna according to an exemplary embodiment may be used effectively as a compact internal antenna.

While exemplary embodiments have been shown and described, it will be understood by those of ordinary skill in the art that various changes in form and details may be made therein without departing from the spirit and scope of the inventive concept as defined by the following claims.

What is claimed is:

1. A magnetic substance comprising a compound represented by
Ba₂₋ₚSrₚCo_{2-y-z}Zn_{y}M¹_{z}Fe_{12-q}M²_{q}O₂₂,
wherein M¹ is at least one element selected from the group consisting of Mn, Cu, Ni, and Mg, M² is at least one element selected from the group consisting of La and Y, p is from about 0 to about 1, y is from about 0.1 to about 0.9, z is from about 0 to about 0.8, and q is from about 0 to about 1.

2. The magnetic substance of claim 1, wherein z is from about 0.1 to about 0.4.

3. The magnetic substance of claim 1, wherein the magnetic substance has a relative magnetic permeability of 2 or greater over a bandwidth of 100 MHz through 3 GHz.

4. The magnetic substance of claim 1, wherein the magnetic substance has a magnetic permeability loss of about 0.9 or lower over a bandwidth of 100 MHz through 3 GHz.

5. The magnetic substance of claim 1, wherein the magnetic substance further comprises silicate glass.

6. The magnetic substance of claim 1, wherein the magnetic substance is in a powder form and has an average particle size of from about 0.5 μm to about 5 μm.

7. A method of manufacturing a magnetic substance comprising:
forming a slurry mixture by mixing 2-p parts by mole of a Ba-precursor based on an amount of Ba, about p parts by mole of an Sr-precursor based on an amount of Sr, about 2-y-z parts by mole of a Co-precursor based on an amount of Co, about y parts by mole of a Zn-precursor based on an amount of Zn, about z parts by mole of an M¹-precursor based on an amount of M¹, about 12-q parts by mole of an Fe-precursor based on an amount of Fe, and about q parts by mole of an M²-precursor based on an amount of M² in the presence of a dispersion medium, wherein M¹ is at least one element selected from the group consisting of Mn, Cu, Ni, and Mg, the M¹-precursor is at least one compound selected from the group consisting of an Mn-precursor, a Cu-precursor, an Ni-precursor, and an Mg-precursor, M² is at least one element selected from the group consisting of La and Y, the M²-precursor is at least one compound selected from the group consisting of an La-precursor and a Y-precursor, p is from about 0 to about 1, y is from about 0.1 to about 0.9, z is from about 0 to about 0.8, and q is from about 0 to about 1;
forming a dry mixture by drying the slurry mixture; and
forming a magnetic substance by calcining the dry mixture.

8. The method of claim 7, wherein a temperature of the calcining of the dry mixture is within a range of from about 800° C. to about 1,000° C.

9. The method of claim 7 further comprising forming a magnetic substance powder by milling the calcined magnetic substance after the calcining of the dry mixture.

10. The method of claim 7 further comprising:
forming a second slurry mixture by mixing the calcined magnetic substance and silicate glass in the presence of a second dispersion medium;
forming a second dry mixture by drying the second slurry mixture;
forming a compressed mixture by compressing the second dry mixture; and
sintering the compressed mixture.

11. The method of claim 10, wherein the silicate glass is silica glass, fumed silica glass, borosilicate glass, aluminosilicate glass, lithium silicate glass, potassium silicate glass, sodium silicate glass, barium silicate glass, or a mixture thereof.

12. The method of claim 10, wherein the amount of silica glass used is within the range of from about 0.5 parts to about 5 parts by weight based on 100 parts by weight of the calcined magnetic substance.

13. The method of claim 10, wherein a temperature of the sintering is within a range of from about 1,100° C. to about 1,250° C.

14. A composite material for antennas comprising:
a thermoplastic polymer resin matrix; and
a magnetic substance which is dispersed in the matrix, the powder comprising a compound represented by
Ba₂₋ₚSrₚCo_{2-y-z}Zn_{y}M¹_{z}Fe_{12-q}M²_{q}O₂₂
wherein M¹ is at least one element selected from the group consisting of Mn, Cu, Ni, and Mg, M² is at least one element selected from the group consisting of La and Y, p is from about 0 to about 1, y is from about 0.1 to about 0.9, z is from about 0 to about 0.8, and q is from about 0 to about 1.

15. The composite material for antennas of claim 14, wherein the composite material for antennas has a relative magnetic permeability of about 1.5 or greater over a bandwidth of 100 MHz to 3 GHz.

16. The composite material for antennas of claim 14, wherein the composite material for antennas has a magnetic permeability loss of about 0.2 or lessover a bandwidth of 100 MHz to 3 GHz.

17. The composite material for antennas of claim 14, wherein the thermoplastic polymer resin is polycarbonate, polyphenylene oxide, polyphenylene ether, polycarbonate-acrilonitrile/butadiene/styrene, or a mixture thereof.

18. The composite material for antennas of claim 14, wherein the magnetic substance is in powder form and has an average particle size of from about 0.5 μm to about 5 μm.

19. The composite material for antennas of claim 14, wherein the magnetic substance further comprises silicate glass.

20. The composite material for antennas of claim 14, wherein an amount of the magnetic substance in the composite material for antennas is from about 40 wt % to about 80 wt %.

21. An antenna comprising:
the antenna carrier formed of the composite material for antennas of claim 14; and
a resonance circuit pattern formed on a surface of the antenna carrier.

22. The magnetic substance of claim 1, wherein the magnetic substance has a relative magnetic permeability of from 3 to 5 over a bandwidth of 100 MHz through 3 GHz.

23. The magnetic substance of claim 1, wherein the magnetic substance has a magnetic permeability loss of from about 0.1 to about 0.5 over a bandwidth of 100 MHz through 3 GHz.

24. The magnetic substance of claim 1, wherein the magnetic substance is in a powder form and has an average particle size of from about 1 μm to about 3 μm.

25. The composite material for antennas of claim 14, wherein the composite material for antennas has a relative magnetic permeability of from about 2 to about 3.5 over a bandwidth of 100 MHz to 3 GHz.

26. The composite material for antennas of claim 14, wherein the composite material for antennas has a magnetic permeability loss of from about 0.05 to about 0.1 over a bandwidth of 100 MHz to 3 GHz.

27. The composite material for antennas of claim 18, wherein an average particle size of the magnetic substance powder is from about 1 μm to about 3 μm.
